(19) United States
(12) Patent Application Publication
(10) Pub. No.: US 2018/0186941 A1
(43) Pub. Date: Jul. 5, 2018

(54) METHODS OF PREPARING VINYLIDENE CHLORIDE POLYMER COMPOSITIONS

(71) Applicant: Dow Global Technologies LLC, Midland, MI (US)

(72) Inventors: Huiqing Zhang, Midland, MI (US); Douglas E. Beyer, Midland, MI (US); John A. Naumovitz, Midland, MI (US)

(21) Appl. No.: 15/738,915

(22) PCT Filed: Aug. 17, 2016
(86) PCT No.: PCT/US2016/047233

§ 371 Date: Dec. 21, 2017

Related U.S. Application Data
(60) Provisional application No. 62/212,089, filed on Aug. 31, 2015.

(51) Int. Cl. C08J 3/16; C08J 3/00; C08L 27/08

(52) U.S. Cl. CPC C08J 3/16; C08J 3/005; C08L 27/08; C08L 2205/03; C08J 2433/00; C08J 2423/06; C08J 2327/08

(57) ABSTRACT

The present invention relates generally to methods of preparing vinylidene chloride polymer compositions. In one embodiment, a method of preparing a vinylidene chloride polymer composition comprises (a) adding a first dispersion comprising a wax, a polyolefin or a combination thereof to an aqueous dispersion comprising vinylidene chloride polymer particles; (b) adding an acrylic polymer latex to the aqueous dispersion; and (c) coagulating the wax, the polyolefin, or the combination of the wax and polyolefin, and the acrylic polymer on the surface of the polymer particles.

### FIELD

The disclosure relates to methods of preparing vinylidene chloride polymer compositions and to vinylidene chloride polymer compositions formed from such methods.

### INTRODUCTION

Vinylidene chloride polymers are known to be useful in the fabrication of packaging films for oxygen-sensitive materials such as food products. Processing aids and additives such as plasticizers, lubricants, and thermal stabilizers have been used to improve the thermal stability and extrusion performance of vinylidene chloride polymers or copolymers. Liquid additives such as various plasticizers can be added as part of monomer feed during polymerization. As described in U.S. Pat. No. 6,627,679, some acrylic processing aid has been added as a latex directly into the vinylidene chloride copolymer slurry after polymerization and then coagulated with vinylidene chloride copolymer with brine. However, many solid additives such as wax and polyolefin lubricants are typically blended into the finished polymer using high intensity mixers. To minimize the potential negative effect of additives on barrier properties, the amount of additives used is typically very small. Therefore, the dry blending method can potentially result in non-uniform distribution of additives on the surface of vinylidene chloride polymer particles and sometimes in formation of agglomerates. In addition, due to significant differences between the particle size of vinylidene chloride polymer and the additives, the dry blends can easily segregate during transportation or conveying process, which can lead to inconsistent extrusion and film performance. New methods of making vinylidene chloride polymer compositions would thus be beneficial.

### SUMMARY

The present invention provides methods of making vinylidene chloride polymer compositions. The present invention also provides polyvinylidene chloride polymer compositions made from such methods which exhibit one or more desirable properties. For example, in some embodiments, the polyvinylidene chloride polymer compositions can advantageously provide a combination of desirable properties (e.g., metal release, low shear heating, low melt temperature, improved thermal stability and extrusion at high extrusion rates, barrier properties, and/or optical properties), while not being prone to segregation during shipment and handling. In various embodiments, methods of the present invention can have several advantages over physical blending and other additive addition methods (e.g., adding dry powder directly into the slurry), including easy mixing, reduction or elimination of additional post processing, high incorporation and uniform distribution of additives, and/or more effective and consistent improvement in thermal stability and extrusion performance. In one aspect, the present invention provides a method of preparing a vinylidene chloride polymer composition that comprises (a) adding a first dispersion comprising a wax, a polyolefin or a combination thereof to an aqueous dispersion comprising vinylidene chloride polymer particles; (b) adding an acrylic polymer latex to the aqueous dispersion; and (c) coagulating the wax, the polyolefin, or the combination of the wax and polyolefin, and the acrylic polymer on the surface of the polymer particles.

These and other embodiments are described in more detail in the Detailed Description.

### DETAILED DESCRIPTION

Unless specified otherwise herein, percentages are weight percentages (wt %) and temperatures are in ° C.

The term “composition,” as used herein, includes a mixture of materials which comprise the composition, as well as reaction products and decomposition products formed from the materials of the composition.

The term “comprising,” and derivatives thereof, is not intended to exclude the presence of any additional component, step or procedure, whether or not the same is disclosed herein. In order to avoid any doubt, all compositions claimed herein through use of the term “comprising” may include any additional additive, adjuvant, or compound whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed. The term “or”, unless stated otherwise, refers to the listed members individually as well as in any combination.

“Polymer” means a polymeric compound prepared by polymerizing monomers, whether of the same or a different type. The generic term polymer thus embraces the term homopolymer (employed to refer to polymers prepared from only one type of monomer, with the understanding that trace amounts of impurities can be incorporated into the polymer structure), and the term interpolymer as defined hereinafter. Trace amounts of impurities (for example, catalyst residues) may be incorporated into and/or within the polymer. A polymer may be a single polymer, a polymer blend or polymer mixture.

The term “interpolymer,” as used herein, refers to polymers prepared by the polymerization of at least two different types of monomers. The generic term interpolymer thus includes copolymers (employed to refer to polymers prepared from two different types of monomers), and polymers prepared from more than two different types of monomers.

The term “polymer molecular weight” is used herein to designate the weight average molecular weight in Daltons. It is measured by size exclusion chromatography using polystyrene calibration.

The term “plasticizer” as used herein refers to a substance or material incorporated into a polymer composition to increase the flexibility, pliability or softness of the polymer or a final product made from it, for instance a film or fiber. Usually, a plasticizer lowers the glass transition temperature of the plastic, making it softer. However, strength and hardness often decrease as a result of added plasticizer.

Embodiments of the present invention generally relate to methods of preparing vinylidene chloride polymer compositions. In one embodiment, a method of preparing a vinylidene chloride polymer composition comprises (a) adding a first dispersion comprising a wax, a polyolefin or a combination thereof to an aqueous dispersion comprising vinylidene chloride polymer particles; (b) adding an acrylic polymer latex to the aqueous dispersion; and (c) coagulating the wax, the polyolefin, or the combination of the wax and polyolefin, and the acrylic polymer on the surface of the polymer particles. In some embodiments, methods of the present invention further comprise drying the vinylidene chloride polymer composition.

In some embodiments, the acrylic polymer latex comprises monomer units derived from at least one of alkyl acrylate, alkyl methacrylate, styrenic monomer, or combinations thereof. In some embodiments, the acrylic polymer comprises monomer units derived from butyl acrylate, butyl methacrylate, and/or methyl methacrylate. The amount of acrylic polymer latex that can be added in various embodiments is discussed in more detail herein.

In some embodiments, a second dispersion comprising a wax, a polyolefin, or a combination thereof can be added to the aqueous dispersion.

In some embodiments, the first dispersion comprises an anionic surfactant while in other embodiments, the first dispersion comprises a non-ionic surfactant. In embodiments comprising multiple dispersions, the dispersions can each comprise anionic surfactants, or the dispersions can each comprise non-ionic surfactants, or some dispersions can comprise anionic surfactants and others can comprise non-ionic surfactants.

In some embodiments, the coagulating step comprises adding a chemical coagulant to the aqueous dispersion comprising the latex and the wax, the polyolefin, or the combination of the wax and polyolefin. The chemical coagulant, in some embodiments, comprises an inorganic salt of a metallic ion. In various embodiments, the coagulation temperature can be from 60° C. to 120° C., or from 70° C. to 110° C., or from 80° C. to 100° C.

In some embodiments where the first dispersion comprises at least one wax, the wax can be a paraffin wax such as a Fischer-Tropsch paraffin wax. In some embodiments the wax can be oxidized.

In some embodiments where the first dispersion comprises at least one polyolefin, the polyolefin can be a polyethylene. The polyethylene, in some embodiments, can be a high density polyethylene having a density greater than 0.940 g/cm³. In some embodiments, the polyethylene is oxidized.

The amounts of wax and/or polyolefin that can be provided in the vinylidene chloride polymer compositions made using methods of the present invention are set forth in more detail herein (e.g., in connection with the discussion of the various components). In some embodiments, the wax, polyolefin, or combination thereof is present in an amount of 0.01 to 7 weight percent of the vinylidene chloride polymer composition, or 0.2 to 7 weight percent in other embodiments. The wax, polyolefin, or combination thereof, in some embodiments, is present in an amount of 0.03 to 2 weight percent of the vinylidene chloride polymer composition. In some embodiments, the wax, polyolefin, or combination thereof is present in an amount of 0.2 to 2 weight percent of the vinylidene chloride polymer composition. The wax, polyolefin, or combination thereof is present in an amount of 0.05 to 1 weight percent of the vinylidene chloride polymer composition in some embodiments. The wax, polyolefin, or combination thereof, in some embodiments, is present in an amount of 0.2 to 1 weight percent of the vinylidene chloride polymer composition. In some embodiments, the vinylidene chloride polymer composition comprises 0.01 to 1 weight percent of a wax and 0.1 to 1 weight percent of a polyolefin.

In some embodiments, methods of the present invention further comprise forming the aqueous dispersion of vinylidene chloride polymer particles by copolymerizing a monomer mixture comprising from 60 to 99 weight percent vinylidene chloride monomer and from 40 to 1 weight percent of a monoethylenically unsaturated comonomer. In some embodiments, the monoethylenically unsaturated monomer is vinyl chloride, alkyl acrylate, alkyl methacrylate, acrylic acid, methacrylic acid, itaconic acid, acrylonitrile, or methacrylonitrile, and combinations thereof. In some embodiments, the monoethylenically unsaturated monomer is methyl acrylate.

In some embodiments, the aqueous dispersion comprises at least one plasticizer. The at least one plasticizer, in some embodiments, comprises epoxidized soybean oil, epoxidized linseed oil, epoxidized esters, dibutyl sebacate, acetyl tributyl citrate, other citrate esters, other polymeric or high molecular weight ester oils, or combinations thereof. The amount of plasticizer that can be added in various embodiments is discussed in more detail herein.

In some embodiments, the vinylidene chloride polymer is in the form of particles, and one or more of the other components (e.g., the acrylic polymer, the wax, and/or the polyethylene) are coagulated on the surface of the vinylidene chloride polymer particles.

The vinylidene chloride polymer composition, in some embodiments, can further comprise other additives such as heat or thermal stabilizers, light stabilizers, antiblocks, acid scavengers, pigments, processing aids, lubricants, fillers, and/or antioxidants, and combinations thereof. In some embodiments, such additives can added to the vinylidene chloride polymer composition in a later blending operation, although some such additives could also be added prior to coagulation.

Embodiments of the present invention also relate to articles formed from any of the vinylidene chloride polymer compositions of the present invention. In some embodiments, the article can be a film or a multilayer film. Some embodiments relate to a package comprising a film formed from any of the vinylidene chloride polymer compositions of the present invention. In some embodiments, the package comprises a food package and can further comprise a food item.

The discussion will now focus in more detail on the various components that can be used in various embodiments of methods of the present invention preparing vinylidene chloride polymer compositions.

### Vinylidene Chloride Polymer

As used herein, the term “vinylidene chloride polymer” encompasses copolymers and interpolymers comprising vinylidene chloride, wherein the major component is vinylidene chloride and the remainder is one or more monoethylenically unsaturated comonomer copolymerizable therewith. For vinylidene chloride polymers, an effective amount of polymerized vinylidene chloride monomer is generally in the range of from 60 to 100 percent by weight of polymer. The amount of monoethylenically unsaturated comonomer copolymerizable therewith is generally in the range of 1 to 40 weight percent by weight of polymer. Monoethylenically unsaturated monomers which can be employed in the practice of the present invention for preparing the vinylidene chloride polymers include vinyl chloride, alkyl acrylates, alkyl methacrylates, acrylic acid, methacrylic acid, itaconic acid, acrylonitrile, methacrylonitrile, and combinations thereof. Preferred monoethylenically unsaturated monomers include acrylonitrile, methacrylonitrile, alkyl acrylates, alkyl methacrylates, and combinations thereof. More preferred monoethylenically unsaturated monomers include acrylonitrile, methacrylonitrile, and the alkyl acrylates and alkyl methacrylates having from 1 to 8 carbon atoms per alkyl group. Most preferably, the alkyl acrylates and alkyl methacrylates are methyl acrylates, ethyl acrylates, butyl acrylates, and/or methyl methacrylates. In some embodiments, the monoethylenically unsaturated monomer is methyl acrylate.

In some embodiments, the vinylidene chloride polymer comprises an interpolymer formed from the copolymerization of vinylidene chloride with methyl acrylate. In some such embodiments, the vinylidene chloride polymer is formed from a monomer mixture comprising 80 to 99 weight percent vinylidene chloride and 1 to 20 weight percent of methyl acrylate. In some such embodiments, the vinylidene chloride polymer is formed from a monomer mixture comprising 84 to 98 weight percent vinylidene chloride and 2 to 16 weight percent of methyl acrylate. In some such embodiments, the vinylidene chloride polymer is formed from a monomer mixture comprising 90 to 97 weight percent vinylidene chloride and 3 to 10 weight percent of methyl acrylate. Weight percent is based on total weight of the vinylidene chloride polymer.

Vinylidene chloride polymers are known and are commercially available. Processes for preparing them, such as by emulsion or suspension polymerization process, are also familiar to persons of ordinary skill in the art. See, for example, U.S. Pat. Nos. 2,558,728; 3,007,903 and 3,879,359.

One exemplary method for the preparation of vinylidene chloride polymers is a batch suspension process. In such a process, organic components including vinylidene chloride, monoethylenically unsaturated comonomer(s), and initiator are added to the reactor. Aqueous components including deionized water and suspending agent are also added to the reactor. Other optional components can include organic components such as plasticizers or antioxidants and aqueous components such as buffers or metal chelating agents. Mixing is applied to the batch to create a suspension. The specific order of addition, mixing and proportions of organic and aqueous phases are variable, but are generally completed in a manner to insure that all organic components are uniformly dispersed and upon mixing, an organic in aqueous suspension is created.

After the reaction mixture is loaded, it is heated to initiate the polymerization reaction. Polymerization temperatures are generally in the range of 30 to 90° C. Reaction is normally allowed to proceed to a conversion of monomer to polymer of between 70 and 99%. At this point the polymerization mixture is in the form of polymer particles, generally 150 to 350 micron volume average particle size, suspended in the aqueous phase. Once the polymerization is completed to the desired conversion, the reactor may be vented. Additional heat and vacuum may be applied to assist in removal of residual monomers. While in this slurry state, additional components including, for example, plasticizers, stabilizers and processing aids, can be added.

After the removal of residual monomers and addition of further additives, the resin slurry is dewatered and dried. In its final form, the vinylidene chloride polymer is a dry powder comprising spherical particles that are in the range of 150 to 350 microns (volume median particle size). The dry resin can be optionally blended with other additives in a post-blending operation.

In some embodiments, a vinylidene chloride polymer composition comprises 75 to 99 weight percent vinylidene chloride polymer based on the weight of the polymer composition. A vinylidene chloride polymer composition, in some embodiments, comprises 85 to 99 weight percent vinylidene chloride polymer based on the weight of the polymer composition. A vinylidene chloride polymer composition comprises 90 to 99 weight percent vinylidene chloride polymer based on the weight of the polymer composition in some embodiments. In some embodiments, a vinylidene chloride polymer composition comprises 93 to 99 weight percent vinylidene chloride polymer based on the weight of the polymer composition. A vinylidene chloride polymer composition, in some embodiments, comprises 75 to 98 weight percent, or 85 to 98 weight percent, or 90 to 98 weight percent, or 93 to 98 weight percent vinylidene chloride polymer.

### Acrylic Polymer

Embodiments of vinylidene chloride polymer compositions of the present invention comprise an acrylic polymer. In some embodiments, the acrylic polymer is a methacrylic polymer. The acrylic polymer can be prepared from monomers comprising at least one alkyl acrylate (e.g., butyl acrylate) or alkyl methacrylate (e.g., butyl methacrylate, methyl methacrylate) monomer, or a combination thereof, optionally with at least one styrenic monomer or a combination thereof; that is, having mer units from the alkyl acrylate and/or the alkyl methacrylate monomer or monomers and optionally from styrenic monomer or monomers.

In some embodiments, the acrylic polymer comprises methyl methacrylate, in an amount of at least 30, or at least 40, or at least 50 wt %, and at least one additional methacrylic or acrylic alkyl ester or styrenic monomer or combinations thereof, or at least one additional methacrylic or acrylic alkyl ester. The alkyl groups of the alkyl acrylate and methacrylate monomers have at least 1 carbon atom, to at most 16 carbon atoms, or at most 8 carbon atoms, or at most 4 carbon atoms.

In some embodiments, the acrylic polymer comprises methacrylate and acrylate ester monomers, for polymerization with methyl methacrylate including such monomers as methyl acrylate, ethyl acrylate, butyl acrylate, ethyl methacrylate, butyl methacrylate, styrenic monomers such as styrene, alpha-methyl styrene, para-methyl styrene, para-tert-butyl styrene, and combinations thereof.

In some embodiments, the acrylic polymer has a polymer molecular weight of at least 100,000, or at least 150,000, or at least 200,000, to at most 4,000,000, or at most 700,000, or at most 500,000 Daltons. In some embodiments, a plurality of acrylic polymers can be provided having a variety of molecular weights (e.g., a low molecular weight fraction and a high molecular weight fraction).

In some embodiments, the acrylic polymer is a polymer comprising an acrylate monomer, a methacrylate monomer, a styrene monomer, and combinations thereof. Nonlimiting examples of suitable acrylate polymer include methyl acrylate, butyl acrylate, methyl methacrylate, butyl methacrylate and styrene.

In some embodiments, the acrylate polymer is an interpolymer of methyl methacrylate, butyl methacrylate and butyl acrylate.

The acrylic polymers may be produced in an emulsion polymerization process as known to those of skill in the art. Such processes can also include a continuous addition (con-add) component where monomers and initiators may be added throughout portions of the polymerization. Single or multiple con-adds may be employed, creating a polymer particle that is of a single composition or layers of multiple compositions or molecular weights.

The amount of acrylic polymer present in the composition, in various embodiments, is from 0.1 wt %, or 0.3 wt %, or 0.5 wt %, to 3 wt %, or 5 wt %, or 10 wt %. For example, in some embodiments, the acrylic polymer is present in an amount from 0.1 to 10 wt %, or from 0.3 to 5 wt %, or from 0.5 to 3 wt %. Weight percent is based on total weight of the composition.

The acrylic polymer can be spray dried and dry blended with the vinylidene chloride polymer. The acrylic polymer can also be provided in the form of a latex and added to an aqueous slurry with the vinylidene chloride polymer. Acrylic polymers in the form of a latex, as well as processes for preparing polymer latexes, are known. Additional description regarding acrylic polymers in the form of a latex can be found in U.S. Pat. No. 6,627,769. In connection with methods of the present invention for preparing vinylidene chloride polymer compositions, the acrylic polymer is preferably added as a latex.

One example of a commercially available acrylic polymer in latex form is Plastistrength L-1000, which is commercially available from Arkema Group.

Wax and/or Polyolefin

Embodiments of vinylidene chloride polymer compositions of the present invention comprise a wax, a polyethylene, or a combination thereof. The wax and/or polyethylene can be coagulated on the surface of vinylidene chloride polymer particles. The inclusion of wax and/or polyolefin in the compositions is believed to provide desirable processing performance (e.g., low metal adhesion, low melt temperature, good extrusion performance) as well as desirable film properties.

In connection with methods of the present invention for preparing vinylidene chloride polymer compositions, the wax and/or polyolefin is preferably added as one or more dispersions.

In some embodiments, the polymer composition comprises a wax. The wax is oxidized in some embodiments, and not oxidized in others. Examples of waxes that can be included in embodiments of the present invention include paraffin wax, microcrystalline wax, and modified paraffin wax such as Fischer-Tropsch wax. In some embodiments, the wax comprises paraffin wax. In some embodiments, the wax has a molecular weight of at least 400 and a melting point of at least 50° C., or a molecular weight of at least 500 and a melting point of at least 70° C., or a molecular weight of at least 600 and a melting point of at least 90° C.

Multiple waxes can be included in some embodiments of compositions of the present invention.

In embodiments where the composition comprises a wax, the wax is provided as a dispersion. In such embodiments, the dispersion can comprise a surfactant. In some embodiments, the dispersion is made with a non-ionic surfactant to provide a non-ionic dispersion, while in other embodiments, the dispersion is made with an anionic surfactant to provide an anionic dispersion.

The total amount of wax present in the composition, in various embodiments where wax is a component, is from 0.01 wt %, or 0.03 wt %, or 0.05 wt %, to 1 wt %, or 2 wt %, or 5 wt %. For example, in some embodiments, wax is present in an amount from 0.01 to 5 wt %, or from 0.03 to 2 wt %, or from 0.05 to 1 wt %. Weight percent is based on total weight of the composition.

One example of a commercially available modified paraffin wax that can be used in some embodiments is Vestowax SH-105, which is a non-functionalized Fischer-Tropsch hard paraffin wax commercially available from Evonik Corporation. Some modified paraffin waxes are commercially available as powders but can be made into dispersions using techniques known to those of skill in the art.

In some embodiments, the composition comprises at least one polyolefin such as polyethylene. The polyolefin is oxidized in some embodiments, and not oxidized in others. One example of a polyolefin that can be used in some embodiments is high density polyethylene (HDPE). The HDPE has a density of greater than 0.940 g/cm³. In some embodiments, the polyethylene has a molecular weight of 1,000 to 10,000 g/mol.

Multiple polyolefins can be included in some embodiments of compositions of the present invention.

In embodiments where the composition comprises a polyolefin, the polyolefin is provided as a dispersion. In such embodiments, the dispersion can comprise a surfactant. In some embodiments, the dispersion is made with a non-ionic surfactant to provide a non-ionic dispersion, while in other embodiments, the dispersion is made with an anionic surfactant to provide an anionic dispersion.

In some embodiments, the polyolefin can be a masterbatch of high molecular weight, functionalized poly(dimethylsiloxane) (PDMS) dispersed in a high density polyethylene.

The total amount of polyolefin present in the composition, in various embodiments comprising at least one polyolefin, is from 0.1 wt %, or 0.2 wt %, or 0.3 wt %, to 1 wt %, or 2 wt %, or 5 wt %. For example, in some embodiments, one or more polyolefins are present in an amount from 0.1 to 5 wt %, or from 0.2 to 2 wt %, or from 0.3 to 1 wt %. Weight percent is based on total weight of the composition.

One example of a commercially available polyolefin that can be used in some embodiments is A-C 316A high density oxidized polyethylene, which is commercially available from Honeywell Corporation. Another commercially available polyolefin that can be used in some embodiments is Alathon H5057 high density polyethylene, which is commercially available from Equistar. While some such polyolefins may be commercially available as a powder, such powders can be made into dispersions using techniques known to those of skill in the art. Another commercially available polyolefin dispersion that can be used in some embodiments is Michem Emulsion 61335, which is an anionic high density polyethylene dispersion (anionic surfactant) commercially available from Michelman, Inc. Another commercially available polyolefin dispersion that can be used in some embodiments is Michem Emulsion 98635, which is a non-ionic high density dispersion (non-ionic surfactant) commercially available from Michelman, Inc.

In some embodiments, compositions of the present invention can comprise at least one wax and at least on polyolefin. In such embodiments, the at least one wax and the at least one polyolefin can be any of those disclosed herein. The total amount of wax and polyolefin present in such embodiments is from 0.01 wt %, or 0.03 wt %, or 0.05 wt %, or 0.1 wt %, or 0.2 wt %, to 1 wt %, or 2 wt %, or 5 wt %, or 7 wt %. For example, in some embodiments, the wax and polyolefin(s) are present in an amount from 0.01 to 5 wt %, or from 0.03 to 2 wt %, or from 0.05 to 1 wt %, or from 0.2 to 7 wt %, or from 0.2 to 5 wt %, or from 0.2 to 2 wt %, or from 0.2 to 1 wt %. Weight percent is based on total weight of the composition.

The at least one wax and/or polyolefin may be incorporated by adding the wax and/or polyolefin(s) in the form of a dispersion to an aqueous slurry of vinylidene chloride polymer particles, and then add a coagulant to coagulate the wax and/or polyolefin(s) on the surfaces of the vinylidene chloride polymer particles. Further information on the coagulation process is provided herein. In addition to the wax and/or polyolefin, other additives such as those discussed below (e.g., stabilizers, pigments, etc.) can also be incorporated into the dispersant, and then likewise coagulated on the surfaces of the vinylidene chloride polymer particles.

### Plasticizer

In some embodiments, vinylidene chloride polymer compositions of the present invention can further comprise a plasticizer. In some embodiments, the plasticizer can be present in an aqueous dispersion of vinylidene chloride polymer particles prior to addition of acrylic polymer, wax, and/or polyolefin. In other embodiments, the plasticizer can be incorporated into the vinylidene chloride polymer particles prior to addition of acrylic polymer, wax, and/or polyolefin.

In embodiments comprising a plasticizer, the plasticizer has a molecular weight of a least 300 Daltons. In various embodiments, the plasticizer has a molecular weight of at least 500 Daltons, or 700 Daltons, or 800 Daltons to 2,000 Daltons, or 5,000 Daltons, or 10,000 Daltons.

In some embodiments, the plasticizer is an epoxy plasticizer, that is, a plasticizer having at least one epoxy group per molecule. Nonlimiting examples of suitable epoxy plasticizers include epoxidized soybean oil, epoxidized linseed oil, expoxidized sunflower oil, expoxidized vegetable oil, expoxidized esters, and combinations thereof.

In some embodiments, the plasticizer comprises an ester plasticizer, such as an aliphatic ester plasticizer. Nonlimiting examples of suitable ester plasticizers include dibutyl sebacate, acetyl tributyl citrate (ATBC), other citrate esters, other polymeric or high molecular weight ester oils, advantageously having a molecular weight of at least about 300 and combinations thereof.

In some embodiments, vinylidene chloride polymer compositions of the present invention comprise multiple plasticizers.

The total amount of plasticizer in embodiments where one or more plasticizers are present is from 0.1 wt %, or 0.3 wt %, or 0.5 wt %, to 3 wt %, or 5 wt %, or 10 wt %. For example, in some embodiments, the plasticizer(s) is present in an amount from 0.1 to 10 wt %, or from 0.3 to 5 wt %, or from 0.5 to 3 wt %. Weight percent is based on total weight of the composition.

### Additives

In some embodiments, vinylidene chloride polymer compositions of the present invention may optionally include one or more additives. Nonlimiting examples of suitable additives include UV or light stabilizers, heat or thermal stabilizers, acid scavengers (e.g., tetrasodium pyrophosphate (TSPP), calcium oxide, calcium hydroxide, magnesium oxide, magnesium hydroxide, magnesium aluminum hydroxide carbonate (hydrotalcite, DHT-4A)), pigments, processing aids, lubricants (e.g., calcium stearate, calcium stearyl lactylate), fillers, antioxidants, slip agents and antiblocks (e.g., erucamide, stearamide, calcium carbonate, talc), fluoropolymers, silicon polymers, and combinations thereof.

The total amount of additives in embodiments where one or more additives are present is from 0.01 wt %, or 0.03 wt %, or 0.05 wt %, to 1 wt %, or 3 wt %, or 5 wt %. For example, in some embodiments, the additive(s) are present in an amount from 0.01 to 1 wt %, or from 0.03 to 3 wt %, or from 0.05 to 5 wt %. Weight percent is based on total weight of the composition.

In some embodiments where the acrylic polymer, wax, and/or polyolefin are coagulated on the surface of the vinylidene chloride particles, the composition can be prepared as follows. An aqueous dispersion of vinylidene chloride polymer particles is formed by (1) adding water to a vinylidene chloride polymer that has been dewatered but not dried, or to dried vinylidene chloride polymer, and (2) stirring the mixture to form an aqueous dispersion of vinylidene chloride polymer particles. For example, in one embodiment, the aqueous dispersion of vinylidene chloride polymer particles can be prepared using dried vinylidene chloride particles. In another embodiment, the aqueous dispersion of vinylidene chloride polymer particles is in the polymerization reactor, or downstream from the polymerization reactor, prior to isolating and/or drying the vinylidene chloride polymer particles. A dispersion (or dispersions) comprising wax, oxidized wax, polyolefin, and/or oxidized polyolefin is added to the dispersion of vinylidene chloride polymer particles. The acrylic polymer is added as a latex to the aqueous dispersion of vinylidene chloride polymer particles before, after, or at the same time as the other wax/polyolefin dispersion. In embodiments where the vinylidene chloride polymer particles are in the polymerization reactor or downstream from the reactor, the wax/polyolefin dispersion and/or latex acrylic polymer can be added either to the polymerization reactor before transferring the aqueous dispersion of vinylidene chloride polymer particles to the monomer stripper vessel, or to the monomer stripper vessel as the vinylidene chloride polymer particles dispersion is being heated to a temperature sufficient to vacuum-strip the residual monomer, or to the polymerization reactor or monomer stripper vessel after residual monomers are removed.

After adding the latex acrylic polymer and the dispersion of wax/polyolefin to the aqueous dispersion of vinylidene chloride polymer particles, the latex acrylic polymer and wax/polyolefin dispersion are coagulated on the surface of the polymer particles to coat the particles. The coagulation of the latex acrylic polymer and wax/polyolefin dispersion on the surface of the polymer particles can be done by mechanical means or by adding a chemical coagulant to the aqueous dispersion of vinylidene chloride polymer particles. The dispersion of coated vinylidene chloride polymer particles is then cooled down, unloaded and dewatered and the coated vinylidene chloride polymer particles are collected and further dried.

The coagulants which can be employed in the practice of the present invention are well known in the latex art and include the water soluble inorganic salts of metallic ions. Among the preferred materials are sodium chloride, sodium phosphate, calcium chloride, magnesium chloride, and aluminum sulfate. Acid coagulation (e.g., with hydrochloric acid) can also be used in some embodiments. The coagulant is usually employed in an amount of from 0.5 to 20 percent by weight, although the minimum concentration required to coagulate the latex and wax/polyolefin dispersion is to be preferred. Other techniques known to those of skill in the art for coagulating latexes can also be used based on the teachings herein.

Other additives which impart desirable properties can be incorporated by any suitable technique, for example, by dry blending. Examples of such additives are described above.

Articles

The vinylidene chloride polymer compositions of the present invention can be melt-processed and extruded into any suitable final product, for example, a variety of films or other articles. As is well known in the art, the films and articles are fabricated with conventional coextrusion; for example, feedblock coextrusion, multimanifold die coextrusion, or combinations of the two; injection molding; co-injection molding; extrusion molding; casting; blowing; blow molding; calendering; and laminating.

Exemplary articles include blown and cast, mono and multilayer films; rigid and flexible containers; rigid and foam sheet; tubes; pipes; rods; fibers; and various profiles. Lamination techniques are particularly suited to produce multi-ply sheets. As is known in the art, specific laminating techniques include fusion; that is, whereby self-sustaining lamina are bonded together by applications of heat and pressure; wet-combining, that is, whereby two or more plies are laminated using a tie-coat adhesive, which is applied wet, the liquid driven off, and in one continuous process combining the plies by subsequent pressure lamination; or by heat reactivation, that is, combining a precoated film with another film by heating, and reactivating the precoat adhesive so that it becomes receptive to bonding after subsequent pressure laminating.

The vinylidene chloride polymer compositions of the present invention are particularly suited for fabrication into flexible and rigid containers both in monolayer and multilayer structures used for the preservation of food, drink, medicine and other perishables. Such containers should have good mechanical properties, as well as low gas permeabilities to, for example, oxygen, carbon dioxide, water vapor, odor bodies or flavor bodies, hydrocarbons or agricultural chemicals.

Some embodiments of the invention will now be described in detail in the following Examples.

### EXAMPLES

Materials

The materials used in the comparative and inventive examples are provided in Table 1:

TABLE 1

| Component | Specification |
|---|---|
| PVDC-MA | Poly(vinylidene chloride-co-methyl acrylate) |
| Copolymer 1 | copolymer with 8.5% by weight methyl acrylate and |
| | 2% plasticizer (epoxidized soybean oil) |
| Acrylic | Polymer with monomer unit of methyl methacrylate- |
| Polymer | butyl acrylate-butyl methacrylate as a latex or spray |
| | dried. |
| | Plastistrength L-1000 from Arkema Group |
| Wax | Non-functionalized, Fischer-Tropsch hard paraffin |
| | wax |
| | Vestowax SH-105 from Evonik Corporation |
| Oxidized High | Oxidized high density polyethylene having a density |
| Density | of 0.98 g/cm³ |
| Polyethylene | A-C 316A from Honeywell Corporation |
| (Oxidized | |
| HDPE) | |
| High Density | Dispersion of high density polyethylene with 35% |
| Polyethylene 2 | solids with a non-ionic surfactant |
| (HDPE 1) | Michem ® Emulsion 98635 from Michelman, Inc. |
| High Density | Dispersion of high density polyethylene with 35% |
| Polyethylene 3 | solids with an anionic surfactant |
| (HDPE 2) | Michem ® Emulsion 61335 from Michelman, Inc. |

Multilayer Film Preparation

Multilayer films are coextruded using a blown film line. The nominal thickness is 2.5 mils. The layer distribution (a/b/c/b/a) is DOWLEX™ 2247G/Elvax 3190/PVDC-MA Polymer Composition/Elvax 3190/DOWLEX™ 2247G with corresponding percentages by volume of 35%/10%/10%/10%/35%. DOWLEX™ 2247G is a linear low density polyethylene resin commercially available from The Dow Chemical Company. Elvax 3190 is an ethylene vinyl acetate copolymer commercially available from DuPont. The PVDC-MA Polymer Composition is as specified in the example.

Metal Adhesion Testing

The 2-roll mill test apparatus consists of two counter-rotating heated metal rolls, referred to as the “primary” and “boundary” rolls. These two rolls run at slightly different rpm. In a typical test, the gap between the rolls is closed and polymer is added to the nip area between the rolls where it melts and adheres to the primary roll. The gap between the rolls can be adjusted to provide the desired thickness of resin on the primary roll. Excess polymer forms a molten polymer roll in the nip area between the rolls. As the molten polymer is mixed on the 2-roll mill, it will begin to degrade over time. The primary purpose of the 2-roll mill test is to observe this degradation and the effects of this degradation over time. Typical observed effects include discoloration, gassing and metal adhesion. Observations of metal adhesion are particularly important since it is an indication of potential metal adhesion in an extrusion operation. Metal adhesion during extrusion operation can lead to further polymer degradation and carbon formation. Degraded polymer and carbon can both adversely impact the quality of extruded films and require more frequent cleaning of the extruder and/or die.

Test conditions used for 2-roll mill testing are 180° C. roll surface temperature, 23 rpm and 200 grams of resin sample. The test is run for a total of 30 minutes from the time the resin sample is added to the 2-roll mill. Adhesion observations are made beginning at 3 minutes and every 3 minutes thereafter until 30 minutes. It is desired that the polymer sample sticks to the primary roll only. Undesirable metal adhesion is observed as polymer sticking to the boundary roll. The adhesion is quantified using a 0 to 5 scale of increasing adhesion severity as shown in Table 2. The % of the boundary roll coated with adhered polymer at 30 minutes is also recorded. The test then results in a table of adhesion rating versus time. Lower adhesion ratings for a longer time is considered superior performance. An adhesion rating of 0 through 30 minutes, meaning no adhesion, is most desired.

TABLE 2

| Rating | Observation |
|---|---|
| 0 | No polymer sticking on the boundary roll |
| 1 | Polymer sticking on boundary roll in small spots |
| 2 | Thin layer of polymer over most of boundary roll |
| 3 | Thin layer over most of boundary roll with some thick spots |
| 4 | Thick layer of polymer over most boundary roll |
| 5 | Equal amount of polymer on both rolls |

### Example 1

Example 1 is used to illustrate the benefits of some embodiments of methods of the present invention. As such, “Inventive Ex.” refers to formulation made using embodiments of an inventive method, and “Compar. Ex.” or “Comparative Ex.” refers to formulations made using other methods.

In Table 3, Inventive Exs. 1 and 2 are prepared by an embodiment of a method of the present invention. That is, a dispersion of high density polyethylene (HDPE 1 or HDPE 2) is added directly into the PVDC-MA copolymer slurry (PVDC-MA Copolymer 1) followed by addition of the Acrylic Polymer latex (Plastistrength L-1000), and then followed by coagulation with a sodium chloride (NaCl) brine solution. Comparative Ex. 1 is prepared by direct addition of solid powders of the Wax and Oxidized HDPE into the PVDC-MA copolymer slurry (PVDC-MA Copolymer 1) followed by addition of the Acrylic Polymer latex (Plastistrength L-1000), and then followed by coagulation/flocculation with NaCl brine solution, as described in WO 2013/048747 A1. Comparative Ex. 2 is prepared by coagulation of the Acrylic Polymer latex (Plastistrength L-1000) with NaCl brine solution but without wax or polyolefin dispersions, as described in U.S. Pat. No. 6,627,679.

TABLE 3

| | Compar. | Compar. | Inv. | Inv. |
|---|---|---|---|---|
| Formulation | Ex. 1 | Ex. 2 | Ex. 1 | Ex. 2 |
| PVDC-MA | 97.65 | 98 | 97.5 | 97.5 |
| Copolymer 1 | | | | |
| Acrylic Polymer | 2 | 2 | 2 | 2 |
| (latex) | | | | |
| HDPE 1 | | | 0.5 | |
| HDPE 2 | | | | 0.5 |
| Oxidized HDPE | 0.25 | | | |
| Wax | 0.1 | | | |
| Wax/Polyolefin | In slurry | No wax or | In slurry | In slurry |
| Addition Process | addition of | PE | addition | addition of |
| | solid | additions | of | dispersions |
| | powder | | dispersions | |

### Inventive Ex. 1

700 grams of vinylidene chloride copolymer resin (PVDC-MA Copolymer 1) and 874 grams of deionized (DI) water are added to a 2000 ml beaker. The mixture is stirred with a magnetic stirrer at 350 rpm. 54 grams of a hydroxypropyl methylcellulose solution (1 wt % solution) is added followed by 43.9 grams of tetrasodium pyrophosphate (3 wt % solution). The pH is adjusted to 6.3 by adding 7 grams of HCl solution (1N). The mixture is heated to 88° C. 10.26 grams of the HDPE 1 dispersion (35 wt % solids) is added and allowed to mix for 5 minutes. Then, 37.4 grams of the Acrylic Polymer latex (39.3 wt % solids) is added in the mixture and allowed to mix for 5 minutes. 65.1 grams of NaCl brine solution (21.3 wt %) is slowly added in the mixture over 5 minutes to coagulate the Acrylic Polymer latex and the HDPE 1 dispersion, and then allowed to mix for 5 minutes. The mixture is cooled down to 30° C. and then dewatered and dried at 75° C. for 18 hrs.

In the preparation of Inventive Ex. 1, the HDPE 1 dispersion is directly added into the PVDC-MA copolymer slurry and efficiently dispersed/mixed. All of the HDPE 1 and Acrylic Polymer are effectively coagulated by the NaCl brine solution as indicated by a clear water phase after coagulation.

### Inventive Ex. 2

700 grams of vinylidene chloride copolymer resin (PVDC-MA Copolymer 1) and 874 grams of deionized (DI) water are added to a 2000 ml beaker. The mixture is stirred with a magnetic stirrer at 350 rpm. 54 grams of a hydroxypropyl methylcellulose solution (1 wt % solution) is added followed by 43.9 grams of tetrasodium pyrophosphate (3 wt % solution). The pH is adjusted to 6.3 by adding 7 grams of HCl solution (1N). The mixture is heated to 88° C. 10.15 grams of the HDPE 2 dispersion (35.4 wt % solids) is added and allowed to mix for 5 minutes. Then, 37.4 grams of the Acrylic Polymer latex (39.3 wt % solids) is added in the mixture and allowed to mix for 5 minutes. 65.1 grams of NaCl brine solution (21.3 wt %) is slowly added in the mixture over 5 minutes to coagulate the Acrylic Polymer latex and the HDPE 2 dispersion, and then allowed to mix for 5 minutes. The mixture is cooled down to 30° C. and then dewatered and dried at 75° C. for 18 hrs.

In the preparation of Inventive Ex. 2, the HDPE 2 dispersion is directly added into the PVDC-MA copolymer slurry and efficiently dispersed/mixed. All of the HDPE 2 and Acrylic Polymer are effectively coagulated by the NaCl brine solution as indicated by a clear water phase after coagulation.

### Comparative Ex. 1

700 grams of vinylidene chloride copolymer resin (PVDC-MA Copolymer 1) and 874 grams of DI water are added to a 2000 ml beaker. The mixture is stirred with a magnetic stirrer at 350 rpm. 54 grams of a hydroxypropyl methylcellulose solution (1 wt % solution) is added followed by 43.9 grams of tetrasodium pyrophosphate (3 wt % solution). The pH is adjusted to 6.3 by adding 7 grams of HCl solution (1N). The mixture is heated to 88° C. 1.793 grams of the Oxidized HDPE (solid powder) and 0.717 g of the Wax (solid powder) are added. The agitation speed is increased to 500 rpm and allowed to mix for 10 minutes. Then, 37.4 grams of the Acrylic Polymer latex (39.3 wt % solid) is added in the mixture and allowed to mix for 5 minutes. 65.1 grams of NaCl Brine solution (21.3 wt %) is slowly added in the mixture over 5 minutes to coagulate the Acrylic Polymer latex and allowed to mix for 5 minutes. The mixture is cooled down to 30° C. and then dewatered and dried at 75° C. for 18 hrs.

In the preparation of Comparative Ex. 1, the Wax and the Oxidized HDPE are added as solid powders directly into the PVDC-MA copolymer slurry. These solid powders are not easily dispersed in the slurry until the agitation speed is increased. Aggregates of the Wax powders are also observed due to its low softening point (starting around 50-60° C.). It is also observed that the Wax and the Oxidized HDPE are not completely coagulated due to lack of interaction with NaCl brine solution. As a result, some solid Wax powders are left at the top of water phase, which can potentially result in reactor fouling issues in a large scale production.

### Comparative Ex. 2

700 grams of vinylidene chloride copolymer resin (PVDC-MA Copolymer 1) and 874 grams of DI water are added to a 2000 ml beaker. The mixture is stirred with a magnetic stirrer at 350 rpm. 54 grams of a hydroxypropyl methylcellulose solution (1 wt % solution) is added followed by 43.9 grams of tetrasodium pyrophosphate (3 wt % solution). The pH is adjusted to 6.3 by adding 7 grams of HCl solution (1N). The mixture is heated to 88° C. 37.4 grams of the Acrylic Polymer latex (39.3 wt % solid) is added in the mixture and allowed to mix for 5 minutes. 65.1 grams of NaCl Brine solution (21.3 wt %) is slowly added in the mixture in 5 minutes to coagulate the Acrylic Polymer latex and allowed to mix for 5 minutes. The mixture is cooled down to 30° C. and then dewatered and dried at 75° C. for 18 hrs. Comparative Ex. 2 only includes the Acrylic Polymer latex, but no polyethylene or wax additives.

Metal adhesion testing is carried out on Comparative Ex. 2 and Inventive Exs. 1 and 2 by the two roll mill as described above. The adhesion results of the formulations are shown in Table 4.

TABLE 4

| | | | | | | | | | Surface |
|---|---|---|---|---|---|---|---|---|---|
| | | Sticking rating at | | | | | | | coverage |
| | | different time (mins) | | | | | | | of roll |
| Sample | Additives | 12 | 15 | 18 | 21 | 24 | 27 | 30 | @ 30 mins. |
| Compar. | None | 1 | 2 | 3 | 3 | 3 | 3 | 3 | 100% |
| Ex. 2 | | | | | | | | | (thick spots) |
| Inventive | 0.5% | 0 | 0 | 0 | 0 | 0 | 0 | 0 | 0 |
| Ex. 1 | HDPE 1 | | | | | | | | |
| Inventive | 0.5% | 0 | 0 | 0 | 0 | 0 | 0 | 0 | 0 |
| Ex. 2 | HDPE 2 | | | | | | | | |

Inventive Ex. 1 and Inventive Ex. 2 do not exhibit any metal adhesion when the test is completed at the end of 30 minutes. Comparative Ex. 2 starts to stick to the metal surface around 12 minutes. A thin layer of degraded VDC-MA copolymer fully covered the metal roll surface around 15 minutes and continued to build up with time. This suggests that the effective addition of HDPE by this embodiment of the inventive process can significantly reduce the metal adhesion and thus improve the VDC-MA copolymer thermal stability during extrusion.

Comparative Ex. 3, Inventive Ex. 3, and Inventive Ex. 4 are similar in processes to Comparative Ex. 2, Inventive Ex. 1, and Inventive Ex. 2, respectively, except they are prepared in a larger vessel.

### Comparative Ex. 3

13000 grams of vinylidene chloride copolymer resin (PVDC-MA Copolymer 1) is added to a 10 gallon Pfaudler reactor vessel. A mixture of 16225 grams DI water, 1011 grams of a hydroxypropyl methylcellulose solution (1 wt %), and 816 grams of tetrasodium pyrophosphate (3 wt % solution) is prepared. The pH of this mixture is adjusted to 6.3 by adding 130 grams of HCl solution (1N). This mixture is then added to the reactor vessel and stirred at 100 rpm. The mixture is heated to 88° C. 695 grams of the Acrylic Polymer latex (39.3 wt % solid) is added and the mixture allowed to mix for 5 minutes. 1226 grams of NaCl Brine solution (21.0 wt %) is slowly added to the mixture over 5 minutes to coagulate the Acrylic Polymer latex and then allowed to mix for 5 minutes. The mixture is cooled down to 30° C., dewatered using a basket centrifuge, and dried at 70° C. for 24 hrs.

### Inventive Ex. 3

13000 grams of vinylidene chloride copolymer resin (PVDC-MA Copolymer 1) is added to a 10 gallon Pfaudler reactor vessel. A mixture of 16225 grams of DI water, 1011 grams of a hydroxypropyl methylcellulose solution (1 wt %), and 816 grams of tetrasodium pyrophosphate (3 wt % solution) is prepared. The pH of this mixture is adjusted to 6.3 by adding 130 grams of HCl solution (1N). This mixture is then added to the reactor vessel and stirred at 100 rpm. The mixture is heated to 90° C. 189 grams of HDPE 1 dispersion (35.2 wt % solids) is added and allowed to mix for 5 minutes. Then, 695 grams of the Acrylic Polymer latex (39.3 wt % solid) is added in the mixture and allowed to mix for 5 minutes. 1226 grams of NaCl Brine solution (21.0 wt %) is slowly added to the mixture over 5 minutes to coagulate the Acrylic Polymer latex and the HDPE 1 dispersion and then allowed to mix for 5 minutes. The mixture is cooled down to 30° C., dewatered using a basket centrifuge, and dried at 70° C. for 24 hrs.

### Inventive Ex. 4

13000 grams of vinylidene chloride copolymer resin (PVDC-MA Copolymer 1) is added to a 10 gallon Pfaudler reactor vessel. A mixture of 16225 grams of DI water, 1011 grams of a hydroxypropyl methylcellulose solution (1 wt %), and 816 grams of tetrasodium pyrophosphate (3 wt % solution) is prepared. The pH of this mixture is adjusted to 6.3 by adding 130 grams of HCl solution (1N). This mixture is then added to the reactor vessel and stirred at 100 rpm. The mixture is heated to 90° C. 191 grams of HDPE 2 dispersion (35.4 wt % solids) is added and allowed to mix for 5 minutes. Then, 728 grams of the Acrylic Polymer latex (37.5 wt % solid) is added in the mixture and allowed to mix for 5 minutes. 1210 grams of NaCl Brine solution (21.3 wt %) is slowly added to the mixture over 5 minutes to coagulate the Acrylic Polymer latex and the HDPE 2 dispersion and allowed to mix for 5 minutes. The mixture is cooled down to 30° C., dewatered using a basket centrifuge, and dried at 70° C. for 24 hrs.

Backscatter electron images of the resins produced in Comparative Ex. 3, Inventive Ex. 3, and Inventive Ex. 4 using a scanning electron microscope (SEM) following the procedures described in: Clifford S. Todd and Douglas E. Beyer, “Characterization of the Thickness and Distribution of Latex Coatings on Polyvinylidene Chloride Beads by Backscattered Electron Imaging,” Microscopy and Microanalysis, Vol. 21, Issue 02, pp. 472-479 (April 2015) show that the coagulated additives (Acrylic Polymer latex, HDPE 1, and HDPE 2) are evenly distributed on the surface of the vinylidene chloride/methyl acrylate copolymer beads.

Metal adhesion testing is carried out on Comparative Ex. 3 and Inventive Exs. 3 and 4 by the two roll mill as described above. The adhesion results of the formulations are shown in Table 5.

TABLE 5

| | | | | | | | | | Surface |
|---|---|---|---|---|---|---|---|---|---|
| | | Sticking rating at | | | | | | | coverage |
| | | different time (mins) | | | | | | | of roll |
| Sample | Additives | 12 | 15 | 18 | 21 | 24 | 27 | 30 | @ 30 mins. |
| Compar. | None | 2 | 2 | 2 | 2 | 3 | 4 | 4 | 100% |
| Ex. 3 | | | | | | | | | (thick spots) |
| Inventive | 0.5% | 0 | 0 | 0 | 0 | 0 | 0 | 0 | 0 |
| Ex. 3 | HDPE 2 | | | | | | | | |
| Inventive | 0.5% | 0 | 0 | 0 | 0 | 0 | 0 | 0 | 0 |
| Ex. 4 | HDPE 3 | | | | | | | | |

Coextruded films are made from Comparative Ex. 3, Inventive Ex. 3, and Inventive Ex. 4 using a Larkin 200 blown film line. Each of the Example resins are used to form a typical 5-layer coxtruded film with the cored formed from an Example resin, ethylene-vinyl acetate copolymer tie layers and polyethylene skins. The films produced are approximately 2.5 mils thick with a target vinylidene chloride content of 10%. Extrusion conditions are kept the same for each of the samples produced.

Table 6 shows the extrusion and film testing results.

TABLE 6

| | Compar. | Inv. | Inv. |
|---|---|---|---|
| | Ex. 3 | Ex. 3 | Ex. 4 |
| Extruder Speed (rpm) | 15 | 15 | 15 |
| % vinylidene chloride | 9.7 | 10.5 | 10.1 |
| Pressure P1 (psi) | 4700 | 4700 | 5200 |
| Pressure P2 (psi) | 5500 | 5400 | 5400 |
| Extruder Load (amp | 39 | 34 | 34 |
| Oxygen Permeability | 0.18 | 0.18 | 0.19 |
| (cc-mil/100-in²-atm-d) | | | |
| Haze (%) | 16.2 | 19.3 | 19.0 |

The extruder speed was kept constant for each of the samples produced. The measured vinylidene chloride content for each of the films is near the target of 10%, which indicates that the actual extrusion rate (lb/h) was consistent for each sample. The extruder head pressure (P2) also does not vary significantly between samples. Inventive Examples 3 and 4 each show a reduction in extruder load compared to Comparative Example 3, which is a potential indicator of lower melt temperature and improved extrusion performance.

The oxygen permeability of the films is measured in accordance with ASTM D3985 using a Mocon Oxtran OTR testing system at an oxygen content of 100%, a relative humidity of 90%, and a temperature of 23° C. The films formed from Inventive Compositions 3 and 4 do not show a significant difference in oxygen barrier from the film formed from Comparative Composition 3. The haze of the films is determined in accordance with ASTM D1003. While Inventive Compositions 3 and 4 exhibit a small increase in haze, the haze values are still expected to be acceptable for many potential applications.

That which is claimed:

1. A method of preparing a vinylidene chloride polymer composition, the method comprising:
(a) adding a first dispersion comprising a wax, a polyolefin or a combination thereof to an aqueous dispersion comprising vinylidene chloride polymer particles;
(b) adding an acrylic polymer latex to the aqueous dispersion; and
(c) coagulating the wax, the polyolefin, or the combination of the wax and polyolefin, and the acrylic polymer on the surface of the polymer particles.

2. The method of claim 1, wherein the first dispersion comprises an anionic surfactant.

3. The method of claim 1, wherein the first dispersion comprises a nonionic surfactant.

4. The method of claim 1, further comprising adding a second dispersion comprising a wax, a polyolefin or a combination thereof to the aqueous dispersion.

5. The method of claim 1, wherein the second dispersion comprises an anionic surfactant.

6. The method of claim 1, wherein the second dispersion comprises a nonionic surfactant.

7. The method of claim 1, wherein the coagulating step comprises adding a chemical coagulant to the aqueous dispersion comprising the latex and the wax, the polyolefin, or the combination of the wax and polyolefin.

8. The method of claim 1, wherein the chemical coagulant comprises an inorganic salt of a metallic ion.

9. The method of claim 1, wherein the coagulation temperature is from 60° C. to 120° C., or from 70° C. to 110° C., or from 80° C. to 100° C.

10. The method of claim 1, wherein the first dispersion comprises at least one wax.

11. The method of claim 1, wherein the first dispersion comprises at least one polyolefin.

12. The method of claim 1, wherein the wax, polyolefin, or combination thereof is present in an amount of 0.01 to 5 weight percent of the vinylidene chloride polymer composition.

13. The method of claim 1, wherein the acrylic polymer latex comprises monomer units derived from butyl acrylate, butyl methacrylate, and methyl methacrylate.

14. The method of claim 1, further comprising forming the aqueous dispersion of vinylidene chloride polymer particles by copolymerizing a monomer mixture comprising from 60 to 99 weight percent vinylidene chloride monomer and from 40 to 1 weight percent of a monoethylenically unsaturated comonomer.

15. The method of claim 1, wherein the aqueous dispersion comprises at least one plasticizer, wherein the at least one plasticizer comprises epoxidized soybean oil, epoxidized linseed oil, epoxidized esters, dibutyl sebacate, acetyl tributyl citrate, a citrate ester, a polymeric ester oil, a high molecular weight ester oil, or a combination thereof.
